(19) United States
(12) Patent Application Publication
(10) Pub. No.: US 2026/0253866 A1
(43) Pub. Date: Aug. 27, 2026

(54) METHOD FOR PRODUCING POSITIVE ELECTRODE ACTIVE MATERIAL FOR NONAQUEOUS ELECTROLYTE SECONDARY BATTERY

(71) Applicant: BASF SE, Ludwigshafen Am Rhein (DE)

(72) Inventors: Noriyasu KIMURA, Yamaguti (JP); Tsuyoshi WAKIYAMA, Yamaguti (JP)

(21) Appl. No.: 18/871,237

(22) PCT Filed: Jun. 15, 2023
(86) PCT No.: PCT/EP2023/066184

§ 371 Date: Dec. 3, 2024

(30) Foreign Application Priority Data
Jun. 15, 2022 (JP) 2022-096392

(51) Int. Cl. H01M 4/04; H01M 4/02; H01M 4/485; H01M 4/505; H01M 4/525

(52) U.S. Cl. CPC H01M 4/0471; H01M 4/485; H01M 4/505; H01M 4/525; H01M 2004/028

(57) ABSTRACT

Disclosed herein is a method for producing a positive electrode active material for a nonaqueous electrolyte secondary battery including at least the following steps in succession: (1) mixing at least a positive electrode active material precursor compound and a lithium compound to prepare a powdery mixture; and (2) calcining the powdery mixture obtained in step (1) to produce a calcined material, where the precursor compound is a composite compound including oxygen (O), and at least one element (Me) other than lithium (Li) and O, and where in step (2), the calcined material is produced while the powdery mixture is constantly fluidized at least from the start until the end of calcination.

### TECHNICAL FIELD

The present invention relates to a method for producing a positive electrode active material for a nonaqueous electrolyte secondary battery, with which a positive electrode active material capable of imparting outstanding battery characteristics to a nonaqueous electrolyte secondary battery without any reduction in quality can be manufactured with good production efficiency.

### BACKGROUND ART

Nonaqueous electrolyte secondary batteries which are compact, lightweight, and have a high energy density are known as power sources for driving cellular telephones and notebook personal computers, etc. Among these, widespread use is made of lithium ion secondary batteries which have a large charging/discharging capacity and employ a lithium nickelate material in the positive electrode.

A positive electrode active material having the basic composition: Li(NiM)O₂ (where M is an element including a transition metal, for example) is used as a positive electrode active material for a lithium ion secondary battery, for example, and positive electrode materials such as this are generally obtained by calcination of a mixed powder that contains a precursor compound containing a transition metal, and a lithium compound.

As described in Patent Document 1, for example, when the mixed powder is calcined, the mixed powder may be packed in a calcination vessel such as a saggar or a crucible, conditions such as the temperature and time may be suitably adjusted in a calcination oven such as an electric furnace or a roller hearth kiln, and calcination may be carried out multiple times, as required, but efforts are being made to use apparatuses which are capable of performing heat treatment while fluidizing the material being treated, such as an external-heating rotary kiln, since such apparatuses have higher thermal conduction to the material being treated and are more efficient than the calcination ovens such as mentioned above.

A conventional rotary kiln is an apparatus for pyrolyzing or carbonizing waste, etc. in a waste pyrolysis gasification and melting plant or a waste carbonization plant, as described in Patent Document 2, for example, where waste (material being treated) steadily supplied into an inner cylinder of a kiln main body is fluidized while being lifted and agitated by means of a lifter (lifting blade), and the waste can be heat-treated by indirect heating using hot air which is supplied from the outside and circulated through a heating flow path.

### PRIOR ART DOCUMENTS

### Patent Documents

Patent Document 1: WO 2019/194150 A1
Patent Document 2: JP 4670861 B2

### SUMMARY OF THE INVENTION

### Problems to be Solved by the Invention

When an apparatus such as a conventional rotary kiln, for example, is used for heat treating a single powder of waste or the like, such as disclosed in Patent Document 2, an effect of high thermal conduction is certainly demonstrated, and it is possible to achieve the intended waste pyrolysis or carbonization.

As mentioned above, however, a positive electrode active material for a lithium ion secondary battery is produced by calcining a mixed powder comprising the precursor compound and the lithium compound, rather than a single powder, and when a mixed powder such as this is supplied to an apparatus such as a conventional rotary kiln and heat treated, the mixed powder separates as it is fluidized by the simple lifting and agitation afforded by the lifting blade, and adequate calcination of the mixed powder is not achieved, so there is a problem in terms of reduced quality of the resulting positive electrode active material. Furthermore, when this kind of mixed powder is supplied for heat treatment to an apparatus such as a rotary kiln set to a reduced lifting amount, without the lifting blade being installed, for example, the heat is not conducted uniformly and efficiently to the whole of the mixed powder from an inner cylinder surface (furnace wall) of the kiln main body even if the mixed powder fluidizes, so there is a problem in that the mixed powder is not uniformly calcined, causing the expected reduction in quality of the positive electrode active material.

The present invention takes account of the problems in the prior art such as described above, and the objective thereof lies in providing a method for producing a positive electrode active material for a nonaqueous electrolyte secondary battery, with which a positive electrode active material capable of imparting outstanding battery characteristics to a nonaqueous electrolyte secondary battery without any reduction in quality can be manufactured with good production efficiency.

### Means for Solving the Problems

In order to achieve this objective, the method for producing a positive electrode active material of the present invention is achieved by making adjustments to reduce variations in a ratio of lithium and other elements in calcined materials which are continuously obtained when a mixture of a precursor compound comprising a transition metal and a lithium compound is calcined while being fluidized.

The method (method A) for producing a positive electrode active material for a nonaqueous electrolyte secondary battery according to the present invention comprises at least the following steps in succession:
(1) a step (1) in which at least a positive electrode active material precursor compound and a lithium compound are mixed to prepare a powdery mixture; and
(2) a step (2) in which the powdery mixture obtained in step (1) is calcined to produce a calcined material,
where the precursor compound is a composite compound comprising oxygen (O), and at least one element (Me) other than lithium (Li) and oxygen (O), and where in step (2), the calcined material is produced while the powdery mixture is constantly fluidized at least from the start until the end of calcination, so that a coefficient of variation of a ratio (Li/Me) of an amount of lithium (Li) and a total amount of the element (Me) in the calcined material obtained at a predetermined elapsed time is 1.5% or less for calcined materials obtained at all predetermined elapsed times.

Another embodiment of the present invention relates to a method (method B) for producing a positive electrode active material for a nonaqueous electrolyte secondary battery, comprising at least the following steps in succession:
(1) a step (1) in which at least a positive electrode active material precursor compound and a lithium compound are mixed to prepare a powdery mixture; and
(2) a step (2) in which the powdery mixture obtained in step (1) is calcined to produce a calcined material,
where the precursor compound is a composite compound comprising oxygen (O), and at least one element (Me) other than lithium (Li) and oxygen (O), and
where in step (2), the calcined material is produced while the powdery mixture is constantly fluidized at least from the start until the end of calcination; where step (2) is carried out in a rotary kiln in which one or more lifting blades are provided on a surface portion inside the furnace core tube.

Advantageously, method B is carried out in a way that the coefficient of variation of the ratio (Li/Me) of the amount of lithium (Li) and the total amount of the element (Me) in the calcined material obtained at a predetermined elapsed time is 1.5% or less for calcined materials obtained at all predetermined elapsed times.

Calcination in terms of the present invention means subjection of a material to a thermal (=heat) treatment (sometimes also termed firing), e.g. in a temperature range of from 350 to 1000° C. A calcined (fired) material is thus a material which has been subjected to a heat treatment (firing).

Fluidization in terms of the present invention means to cause the material to flow, independently of its physical state (i.e. independently of whether it is in solid state, or partially or completely molten).

### Advantage of the Invention

The present invention makes it possible to provide methods with which a positive electrode active material capable of imparting outstanding battery characteristics to a nonaqueous electrolyte secondary battery without any reduction in quality can be manufactured with good production efficiency.

### BRIEF DESCRIPTION OF THE FIGURES

FIG. 1 is a schematic cross-sectional view in a radial direction showing an example of a furnace core tube of a rotary kiln in which a lifting blade is provided on a surface portion inside the furnace core tube, which can be used in an embodiment of the methods of the invention for producing a positive electrode active material for a nonaqueous electrolyte secondary battery according to the present invention.

FIG. 2 is a schematic cross-sectional view in a radial direction of a furnace core tube of a rotary kiln in which a lifting blade is provided on a surface portion inside the furnace core tube, in order to illustrate the height of lifting a powdery mixture during lifting and agitation employing the rotary kiln, which is an example of lifting and agitation in the methods for producing a positive electrode active material for a nonaqueous electrolyte secondary battery according to the present invention, where (a) is a schematic cross-sectional view in a radial direction of a furnace core tube in which the installation angle of the lifting blade on the surface portion is 45°, and (b) is a schematic cross-sectional view in a radial direction of a furnace core tube in which the installation angle of the lifting blade on the surface portion is 60°.

FIG. 3 is a schematic cross-sectional view in a radial direction of the furnace core tube of the rotary kiln used in examples 1-1 to 1-3 and examples 2-1 to 2-3, where (a) is a schematic cross-sectional view in a radial direction of a furnace core tube in which the installation angle of lifting blades on the surface portion is 30°, (b) is a schematic cross-sectional view in a radial direction of a furnace core tube in which the installation angle of lifting blades on the surface portion is 45°, and (c) is a schematic cross-sectional view in a radial direction of a furnace core tube in which the installation angle of lifting blades on the surface portion is 60°.

### EMBODIMENT OF THE INVENTION

Embodiments of the present invention will be described below. The following description of preferred embodiments is merely given essentially by way of example, and is not intended to restrict the present invention, methods of application thereof, or usages thereof. Unless stated otherwise, the following applies to method A as well as method B.

A mixed powder comprising at least a precursor compound and a lithium compound is preferably calcined while being fluidized rather than left static, in order to produce a positive electrode active material for a nonaqueous electrolyte secondary battery with high thermal conduction and greater efficiency. However, when a mixed powder such as this, rather than a single powder, is calcined while being fluidized, simple lifting and agitation causes the mixed powder to separate and adequate calcination is not achieved, so the quality of the resulting positive electrode active material is reduced. Furthermore, if the amount of lifting of the mixed powder is reduced, heat is not conducted uniformly and efficiently to the whole of the mixed powder, so uniform calcination is not achieved, causing the expected reduction in quality of the positive electrode active material.

In light of these matters, it is understood that when the mixed powder comprising the precursor compound and the lithium compound is calcined, it is important for the mixed powder to be fluidized so as to achieve high thermal conduction while separation of the mixed powder is suppressed. Suppressing separation of the mixed powder means suppressing variations in the composition of calcined materials caused by separation of the mixture, i.e., suppressing variations in a ratio (Li/Me) of lithium (Li) and an element (Me) other than lithium and oxygen in the calcined materials.

The methods for producing a positive electrode active material for a nonaqueous electrolyte secondary battery according to the present invention comprise at least the following steps in succession:
(1) a step in which at least a positive electrode active material precursor compound and a lithium compound are mixed to prepare a powdery mixture; and
(2) a step in which the powdery mixture obtained in step (1) is calcined to produce a calcined material. These steps will be described in order below.

### <Step (1)>

The positive electrode active material precursor compound used in the preparation of the powdery mixture in step (1) is a composite compound comprising oxygen (O) and at least one element (Me) other than lithium (Li) and O, examples of which include: composite hydroxides, composite oxides obtained by calcining the composite hydroxides, and composite carbonates, which comprise the element Me and are synthesized by normal methods.

There is no particular limitation as to the element Me, which is an element capable of constituting the positive electrode active material and should be appropriately selected according to the composition of the intended positive electrode active material, but examples which may be cited include: nickel (Ni), cobalt (Co), manganese (Mn), magnesium (Mg), aluminum (Al), titanium (Ti), zinc (Zn), niobium (Nb), tungsten (W), molybdenum (Mo), vanadium (V), chromium (Cr), calcium (Ca), iron (Fe), gallium (Ga), strontium (Sr), yttrium (Y), ruthenium (Ru), indium (In), tin (Sn), tantalum (Ta), bismuth (Bi), zirconium (Zr), boron (B), and phosphorus (P), etc. Preferably, Me comprises at least one of nickel (Ni), cobalt (Co), manganese (Mn), magnesium (Mg), aluminum (Al), titanium (Ti), zinc (Zn), niobium (Nb), tungsten (W), molybdenum (Mo), vanadium (V), chromium (Cr), calcium (Ca), iron (Fe), gallium (Ga), strontium (Sr), yttrium (Y), ruthenium (Ru), indium (In), tin (Sn), tantalum (Ta), bismuth (Bi), zirconium (Zr), boron (B) and/or phosphorus (P); and more preferably comprises at least one of nickel (Ni), cobalt (Co), manganese (Mn), magnesium (Mg), aluminum (Al), titanium (Ti), zinc (Zn), niobium (Nb), or tungsten (W). Even more preferably, Me comprises at least Ni, and in particular comprises Ni and at least one of Co, Al and Mn. Specifically, Me comprises Ni, Co and one or both of Al and Mn.

Preferably, the precursor compound comprising oxygen (O) and at least one element (Me) is a composite hydroxide, composite oxide, composite carbonate or a mixed form thereof. “Mixed form” means that the precursor compound comprises two or more of hydroxide, oxide and carbonate. Just by way of example, mixed hydroxide/oxide forms may result from the preparation process if an oxide is to be prepared from the corresponding hydroxide and the conversion is not complete. If the precursor compound is a composite hydroxide, composite oxide, composite carbonate or a mixed form thereof, Me preferably comprises (in addition) one or more of the above-listed metals or semi-metals. Specifically, the precursor compound is a hydroxide, an oxide or a mixed form thereof.

A composite hydroxide, composite oxide, or composite carbonate, etc. containing at least Ni is preferred as the precursor compound, and a composite hydroxide, composite oxide, or composite carbonate, etc. containing at least Ni, Co and Al and/or Mn is more preferred, for example.

There is no particular limitation as to the method of synthesizing the precursor compound, and, by way of example, it is possible to adopt a method in which at least one type of aqueous solution of at least one type of element Me or a compound thereof is prepared in accordance with the composition of the intended positive electrode active material, a blending ratio is adjusted as required, the material is dripped into a stirred reaction tank with one or more types of alkaline aqueous solution, such as sodium hydroxide aqueous solution and ammonia solution, for example, serving as a mother liquor, and the materials are coprecipitated by means of a crystallization reaction which is controlled while sodium hydroxide, etc. is also simultaneously dripped so that the pH is in a suitable range of around 11 to around 13, for example, to thereby obtain a hydroxide, oxide, or carbonate, etc. having a shape in which primary particles agglomerate to form secondary particles.

There is no particular limitation as to the compound of the element Me, but examples thereof include: a nickel compound, cobalt compound, manganese compound, magnesium compound, aluminum compound, titanium compound, zinc compound, niobium compound, or tungsten compound, etc.

There is no particular limitation as to the nickel compound, but examples which may be cited include: nickel sulfate, nickel oxide, nickel hydroxide, nickel nitrate, nickel carbonate, nickel chloride, nickel iodide, and metallic nickel, etc.

There is no particular limitation as to the cobalt compound, but examples which may be cited include: cobalt sulfate, cobalt oxide, cobalt hydroxide, cobalt nitrate, cobalt carbonate, cobalt chloride, cobalt iodide, and metallic cobalt, etc.

There is no particular limitation as to the manganese compound, but examples which may be cited include: manganese sulfate, manganese oxide, manganese hydroxide, manganese nitrate, manganese carbonate, manganese chloride, manganese iodide, and metallic manganese, etc.

There is no particular limitation as to the magnesium compound, but examples which may be cited include: magnesium sulfate, magnesium oxide, magnesium hydroxide, magnesium nitrate, magnesium carbonate, magnesium chloride, magnesium iodide, and metallic magnesium, etc.

There is no particular limitation as to the aluminum compound, but examples which may be cited include: aluminum sulfate, aluminum oxide, aluminum hydroxide, aluminum nitrate, aluminum carbonate, aluminum chloride, aluminum iodide, sodium aluminate, and metallic aluminum, etc.

There is no particular limitation as to the titanium compound, but examples which may be cited include: titanyl sulfate, titanium oxide, titanium hydroxide, titanium nitrate, titanium carbonate, titanium chloride, titanium iodide, and metallic titanium, etc.

There is no particular limitation as to the zinc compound, but examples which may be cited include: zinc sulfate, zinc oxide, zinc hydroxide, zinc nitrate, zinc carbonate, zinc chloride, zinc iodide, and metallic zinc, etc.

There is no particular limitation as to the niobium compound, but examples which may be cited include: niobium oxide, niobium chloride, lithium niobate, and niobium iodide, etc.

There is no particular limitation as to the tungsten compound, but examples which may be cited include: tungsten oxide, sodium tungstate, ammonium paratungstate, tungsten hexacarbonyl, and tungsten sulfide.

The type and blending ratio of the compound of the element Me should be appropriately adjusted so that each element is of the desired type and in the desired ratio, while taking account of the composition of the intended positive electrode active material.

Moreover, a precursor compound obtained by means of a wet reaction as described above may be subjected to a washing treatment and a drying treatment after dewatering. By performing the washing treatment, it is possible to rinse away impurities in the form of sulfate radicals and carbonate radicals, and an Na fraction which are taken into the agglomerated particles during the reaction and adhere to the surface layer. Furthermore, the drying treatment may be performed under an oxidizing atmosphere, etc. at between about 50° C. and about 250° C., for example.

Furthermore, the precursor compound may also be subjected to an oxidation treatment under an oxidizing atmosphere at between about 300° C. and about 800° C., for example. The oxidation treatment causes the precursor compound to oxidize while the impurities are also separated from the precursor compound, and the purity of the precursor compound can also be improved. Furthermore, the bulk density may also be increased, and production efficiency can be improved.

The particle size of the precursor compound is not very critical. In a particular embodiment, it is however in the range of 1 to 30 μm. In this range, the particle size can be determined by usual means, using for example electron microscope photograph (SEM photograph); especially SEM photography as defined below. In case of spherical particles, the particle size refers to the diameter, and in case of non-spherical particles to the largest dimension.

The precursor compound synthesized in the manner above and the lithium compound are then mixed in a predetermined ratio to prepare a powdery mixture. The method of mixing the precursor compound and the lithium compound may employ, for example, a method in which a precursor compound powder and a lithium compound powder are weighed out in a predetermined ratio and dry mixed using a mixing and agitation machine, etc., for example. Furthermore, the blending ratio of the precursor compound and the lithium compound should be appropriately adjusted so that the amount of Li and the total amount of the element Me reaches the desired ratio, while taking account of the composition of the intended positive electrode active material.

There is no particular limitation as to the lithium compound which is mixed with the precursor compound, and various types of lithium salts may be used. Examples of the lithium compound which may be cited include: lithium carbonate, lithium hydroxide monohydrate, anhydrous lithium hydroxide, lithium nitrate, lithium acetate, lithium bromide, lithium chloride, lithium citrate, lithium fluoride, lithium iodide, lithium lactate, lithium oxalate, lithium phosphate, lithium pyruvate, lithium sulfate, and lithium oxide, etc. Lithium carbonate, lithium hydroxide monohydrate, and anhydrous lithium hydroxide are preferred as the lithium compound.

The particle size of the lithium compound is not very critical. Just by way of example, in a particular embodiment, it can be in the range of 1 μm to 10 mm. In this range, the particle size can be determined by usual means, using for example electron microscope photograph (SEM photograph); especially SEM photography as defined below, in the μm range and visual inspection or optical microscopy in the range of 500 μm to 10 mm.

Furthermore, compounds of elements serving as additives may also be added, as required. Compounds such as this may also be added when the precursor compound and the lithium compound are mixed, and methods of addition that may be cited include addition in powder form or spray addition in solution form. It should be noted that there is no particular limitation as to the compounds of elements serving as additives, and compounds of the element Me may be appropriately selected for use, for example.

### <Step (2)>

In step (2), the powdery mixture obtained in step (1) is calcined to produce a calcined material, but it is important for thermal conduction of the powdery mixture as a whole to be uniformly increased while separation of the powdery mixture is suppressed during calcination, in order to obtain a high-quality positive electrode active material. For this reason, an important feature of the production method according to the present invention lies in the fact that, in step (2), the calcined material is produced by calcination of the powdery mixture while it is being constantly fluidized at least from the start until the end of calcination, in other words, while the powdery mixture is always being fluidized.

Unreacted compounds may remain in the calcined material obtained by means of step (2). Taking account of the fact that calcination might again be performed at a higher temperature after step (2), unreacted compounds may also remain, and amounts thereof depend on added amounts of the unreacted compounds and the calcination temperature at which these compounds can react.

Suppressing separation of the powdery mixture comprising the precursor compound and the lithium compound means suppressing variations in the composition of calcined materials caused by separation of the powdery mixture, i.e., suppressing variations in the ratio (Li/Me) of the amount of lithium (Li) and the total amount of the element (Me) other than lithium and oxygen in the calcined materials.

The calcined material is produced in step (2) while the powdery mixture is constantly fluidized at least from the start until the end of calcination, so that a coefficient of variation of Li/Me (also referred to below as the Li/Me variation coefficient) of the calcined material obtained at a predetermined elapsed time is 1.5% or less, preferably 1.3% or less, more preferably 1.2% or less, specifically 1.0% or less for calcined materials obtained at all predetermined elapsed times.

The greater the extent to which separation of the powdery mixture is properly suppressed during calcination, the greater the similarity in composition of N (e.g., N≥10) calcined materials obtained at predetermined elapsed times, and therefore the Li/Me variation coefficient gradually approaches 0%. That is to say, a smaller Li/Me variation coefficient is preferable, and if it is excessively large, this is shown by variations in the compositions of calcined materials obtained at predetermined elapsed times due to separation of the powdery mixture during calcination. In step (2), the powdery mixture is calcined while being constantly fluidized at least from the start until the end of calcination so that the Li/Me variation coefficient is 1.5% or less, preferably 1.3% or less, more preferably 1.2% or less, specifically 1.0% or less for calcined materials obtained at all predetermined elapsed times, e.g., at 1 hour, 2 hours, 3 hours, 4 hours, etc., and therefore variations in composition of all of the calcined materials produced are properly suppressed.

In the present specification, the Li/Me variation coefficient is a value obtained on the basis of the following equation using the standard deviation and mean value of Li/Me for N (N=10) samples taken at random places from the calcined material obtained at a predetermined elapsed time. Furthermore, Li/Me in the calcined materials is obtained by heating and dissolving a sample of 0.2 g of calcined material in 25 mL of a 20% hydrochloric solution, and cooling the materials then transferring them to a 100 mL measuring flask, and introducing pure water (ad 100 ml) to prepare an adjusted liquid, the elements of which are quantitatively determined using suitable analytical methods, such as AES (atomic emission spectroscopy), especially ICP-AES (inductively coupled plasma atomic emission spectrometry; synonymous to inductively coupled plasma optical emission spectrometry, abbreviated as ICP-OES) (using e.g. Optima 8300, produced by PerkinElmer, Inc.).

$$Li / Me variation coefficient ( \% ) = ( standard deviation / mean value \times 100$$

The standard deviation applied here is the sample standard deviation applying Bessel's correction:

$$s = \sqrt{\frac{1}{N - 1} {\sum }_{i = 1}^{N} {( {x}_{i} - \overline{x} )}^{2}}$$

where
s is the (sample) standard deviation
N is the number of data points in the data set (here=10; see above text)
i is a point in the data set (here 1, 2, 3, . . . , 10)
xᵢ is the value of the i^{th} point in the data set
x̅ is the mean value of the data set

In step (2), there is no particular limitation as to the means for constantly fluidizing the powdery mixture at least from the start until the end of calcination so that the Li/Me variation coefficient is equal to or less than the upper limit value for calcined materials obtained at all predetermined elapsed times, but it is possible to use lifting and agitation to agitate the powdery mixture while lifting same.

In order to fluidize the powdery mixture, the powdery mixture may simply be rotated, for example, but by performing lifting and agitation, it is possible to calcine the powdery mixture in a state of high thermal conduction. The lifting and agitation are performed so that the height of the topmost portion of the powdery mixture is preferably between 1.0 times and 1.6 times, and more preferably between 1.0 times and 1.5 times the height of the topmost portion in a state without lifting and agitation, whereby a state of high thermal conduction is more adequately maintained. If the height of the topmost portion of the powdery mixture is greater than 1.6 times the height of the topmost portion in a state without lifting and agitation, there is a risk of separation occurring due to the difference in specific gravity of the components of the powdery mixture when the lifted powdery mixture drops. There is a further risk of scattering of components having a smaller specific gravity due to the force of dropping, again causing separation of the powdery mixture.

The particular importance of the lifting and agitation is as follows. When a powdery mixture is simply calcined while being fluidized, a portion which is especially readily subjected to heat from the furnace wall and a portion which is not readily subjected to this heat are formed in the powdery mixture, and it is thought that this can lead to a reduction in quality. When the powdery mixture is lifted and agitated, however, fluidization also occurs such that the powdery mixture that has not fluidized close to the furnace wall is moved up to the furnace wall and the powdery mixture is effectively replaced at the furnace wall, whereby the portion which is readily subjected to heat from the furnace wall and the portion which is not readily subjected to this heat are not formed in the powdery mixture, and calcination can proceed uniformly.

In order to calcine the powdery mixture most effectively in a state of high thermal conduction and to suppress variations in composition of the calcined materials, it is important for the powdery mixture not to be lifted excessively high in relation to the height of the topmost portion of the powdery mixture in a state without lifting and agitation when the powdery mixture is fluidized by means of lifting and agitation, although this also depends on the likelihood of separation of the powdery mixture as a result of dropping of the powdery mixture.

Moreover, as indicated above, the height of the topmost portion of the powdery mixture achieved by the lifting and agitation is thought to be related to the properties of the powdery mixture, that is to say, at least the particle size of the precursor compound and the particle size of the lithium compound, a particle size ratio of both components, and an angle of repose of the powdery mixture, etc., and the height of lifting may be set commensurately with the properties of the powdery mixture which is supplied for the lifting and agitation.

The lifting and agitation are preferably carried out using a rotary kiln in which one or more lifting blades are provided on a surface portion inside a furnace core tube, and this makes it easy to continuously produce calcined materials.

When the thermal conduction of the powdery mixture is to be improved by means of lifting and agitation, the extent to which the powdery mixture as a whole can receive heat is important, e.g., when a rotary kiln in which one or more lifting blades are provided on the surface portion inside the furnace core tube is used, the extent to which the powdery mixture as a whole can be contacted with the surface (also referred to below as the furnace wall) inside the furnace core tube is important, and this improvement may be realized by appropriately adjusting the rotation speed of the rotary kiln and the packing ratio of the powdery mixture in the rotary kiln, for example.

Meanwhile, care should be taken so that the powdery mixture does not separate when the powdery mixture is fluidized by means of lifting and agitation. For example, when a rotary kiln in which one or more lifting blades are provided on the surface portion inside the furnace core tube is used, it is considered preferable for the installation angle of the lifting blade to be appropriately adjusted and for the angle of repose of the powdery mixture to also be appropriately adjusted while taking account of a relationship of the extent of lifting of the powdery mixture inside the furnace and dead space due to the lifting blade.

When a fixed volume of the powdery mixture is lifted and agitated by means of a rotary kiln in which the one or more lifting blades are provided on the surface portion inside the furnace core tube, the powdery mixture can be most efficiently contacted with the furnace wall by installing the lifting blade in a direction parallel to an axial center direction of the furnace core tube, but, taking account of improving thermal conduction of the powdery mixture while suppressing separation of the powdery mixture, as mentioned above, it is undesirable for the installation angle of the lifting blade to be determined while focusing solely on efficiently contacting the powdery mixture with the furnace wall.

If the installation angle of the lifting blade(s) is excessively large, in other words, if the lifting blade(s) is/are too close to a direction parallel to the axial center direction of the furnace core tube, there is a risk of the powdery mixture separating and scattering as it is lifted and dropped, and this increases variations in Li/Me of the calcined material. If the installation angle of the lifting blade(s) is excessively small, in other words, if the lifting blade(s) is/are too close to a direction perpendicular to the axial center direction of the furnace core tube, dead space is formed between the lifting blade(s) and the furnace wall so that the frequency of contact between the powdery mixture and the furnace wall decreases, there is a risk that optimum heat transfer will not be achieved, and it is not possible to achieve a large amount of lift given the angle of repose of the powdery mixture, so the effect of improving thermal conduction afforded by the lifting and agitation will not be achieved.

Accordingly, when a rotary kiln in which one or more lifting blades are provided on the surface portion inside the furnace core tube is used to constantly fluidize the powdery mixture by means of lifting and agitation, the installation angle of the lifting blade(s) is preferably 15° or greater, more preferably 20° or greater, and 85° or less, more preferably 80° or less, in relation to a direction perpendicular to the axial center direction of the furnace core tube. Preferably, the installation angle is 15° to 85°, more preferably 20° to 80°, even more preferably 25° to 70°, in particular 25° to 65°, and specifically 30° to 60°, in relation to a direction perpendicular to an axial center direction of the furnace core tube.

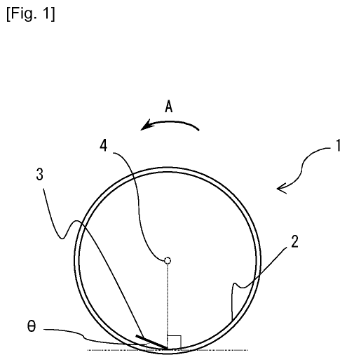

FIG. 1 is a schematic cross-sectional view in a radial direction showing an example of a furnace core tube of a rotary kiln in which a lifting blade is provided on a surface portion inside the furnace core tube, which can be used in an embodiment of the method for producing a positive electrode active material for a nonaqueous electrolyte secondary battery according to the present invention. In FIG. 1, a furnace core tube 1 of the rotary kiln is provided with a plurality of lifting blades 3 on a surface portion 2 thereof, and rotates in the direction of the arrow A. An installation angle θ of the lifting blade 3 is an angle in relation to a direction perpendicular to the direction of an axial center 4 of the furnace core tube 1, and the installation angle θ is preferably adjusted to 15°-85°, as mentioned above.

It should be noted that there is no particular limitation as to the number of lifting blades installed on the surface portion inside the furnace core tube, and the number of lifting blades should be appropriately adjusted in accordance with a retort diameter, etc. so as to achieve thorough lifting and agitation. For example, around 3-6 lifting blades are preferably installed when the retort diameter is around 200 mm-700 mm, and around 4-10 lifting blades are preferably installed when the retort diameter is around 1000 mm-2000 mm.

The angle of repose of the powdery mixture is also related to the particle size of the powdery mixture, but it is important for the angle of repose to be of a magnitude such that the powdery mixture is lifted up to a given height by means of the lifting blades provided at a predetermined installation angle on the surface portion inside the furnace core tube, and to be of a magnitude such that the powdery mixture does not separate when lifted and dropped.

If the angle of repose of the powdery mixture is excessively large, there is poor fluidization of the powdery mixture when it is lifted and dropped, and a risk of the powdery mixture supplied to the lifting and agitation not being smoothly replaced. If the angle of repose of the powdery mixture is excessively small, the powdery mixture fluidizes while in the process of being lifted and dropped, so there is a risk of a reduction in the effect afforded by the lifting and agitation. Accordingly, the angle of repose of the powdery mixture measured by an injection method (according to ISO 902: 1976) is preferably 20°-80°. Furthermore, the angle of repose may be determined using the particle size of the precursor compound and the particle size of the lithium compound constituting the powdery mixture. By appropriately adjusting the particle size of the lithium compound in particular, it is possible to achieve the intended angle of repose of the powdery mixture. Angle of repose in context with the present invention relates to the static angle of repose.

The height of lifting of the powdery mixture will be described here while taking the example of a case in which the powdery mixture is lifted and agitated by using the rotary kiln in which the lifting blades are provided on the surface portion inside the furnace core tube.

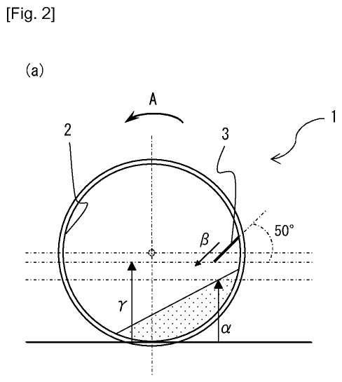

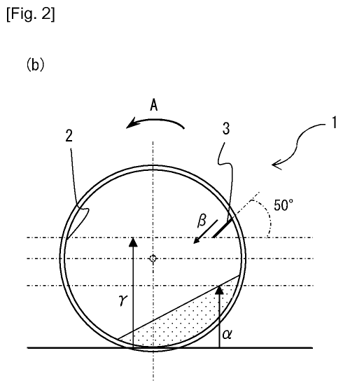

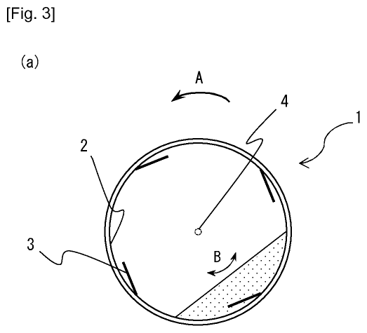

FIG. 2 is a schematic cross-sectional view in a radial direction of a furnace core tube of a rotary kiln in which a lifting blade is provided on a surface portion inside the furnace core tube, in order to illustrate the height of lifting of the powdery mixture during lifting and agitation employing the rotary kiln, which is an example of lifting and agitation in the production method of the present invention, where (a) is a schematic cross-sectional view in a radial direction of a furnace core tube in which the installation angle of the lifting blade on the surface portion is 45°, and (b) is a schematic cross-sectional view in a radial direction of a furnace core tube in which the installation angle of the lifting blade on the surface portion is 60°. When the lifting and agitation are performed using this kind of rotary kiln, the height of lifting of the powdery mixture may be set in accordance with the installation angle of the lifting blade.

As shown in FIGS. 2(a) and (b), when the powdery mixture is fluidized by agitation afforded by the lifting blade, the angle of repose of the powdery mixture is smaller than when there is no lifting blade because of gas taken into the powdery mixture, and the height to which the powdery mixture is raised by rotation of the furnace core tube (=the height of the powdery mixture independently of the lifting blade, arrow α) decreases. During this process, the powdery mixture on top of the lifting blade is further lifted and drops from the lifting blade when the angle thereof exceeds its own angle of repose (arrow β).

At this time, the height of the powdery mixture independently of the lifting blade (the arrow α) is defined as the height of the topmost portion of the powdery mixture in a state without lifting and agitation, and a maximum height (arrow γ) of the powdery mixture which is lifted by means of the lifting blade is defined as the height of the topmost portion of the powdery mixture being lifted and agitated. A value calculated as a multiplying factor (arrow γ/arrow α) of the height of the topmost portion of the powdery mixture being lifted and agitated in relation to the height of the topmost portion of the powdery mixture in a state without lifting and agitation is the height of lifting of the powdery mixture.

For example, in the case of examples 1-2 and 1-3 which will be described later, the angle of repose of a powdery mixture 1 is 43.7°, and in example 1-2 (installation angle of lifting blade: 45°, corresponding to FIG. 2(a)), the height of lifting of the powdery mixture 1 is approximately 1.3 times, and in example 1-3 (installation angle of lifting blade: 60°, corresponding to FIG. 2(b)), the height of lifting of the powdery mixture 1 is approximately 1.6 times.

It should be noted that in a rotary kiln in which no lifting blade is provided on the surface portion inside the furnace core tube, the height of lifting of the powdery mixture is dependent simply on the angle of repose of the powdery mixture, and is higher than the arrow α shown in FIGS. 2(a) and (b).

There are no particular limitations as to the conditions when the powdery mixture is lifted and agitated by means of the rotary kiln in which one or more lifting blades are provided on the surface portion inside the furnace core tube, but the following conditions are preferably taken into account, for example.

### (Retort Rotation Speed)

In order to further improve thermal conduction of the powdery mixture, the retort rotation speed should be increased while maintaining a residence time of the powdery mixture inside the furnace core tube of the rotary kiln, but if the retort rotation speed is excessively high, the lithium conversion afforded by calcination does not progress adequately, and there is a risk of a reduction in the quality of the intended positive electrode active material, while if the retort rotation speed is excessively low, Li may selectively adhere to the furnace wall and there is a risk of variations in the composition of the powdery mixture. Accordingly, the optimum retort rotation speed is preferably adjusted appropriately in accordance with the furnace diameter (retort diameter), etc. The skilled person is aware how to adjust rotation speed to optimize the heat transfer in a specific furnace or can carry out simple preliminary tests. For example, the retort rotation speed may be adjusted to around 0.3 rpm-4.0 rpm when the retort diameter is around 200 mm-1500 mm.

### (Powdery Mixture Packing Ratio)

The packing ratio of the powdery mixture inside the furnace of the rotary kiln (percentage expressed by powdery mixture volume/rotary kiln internal capacity) may be adjusted in accordance with the type of rotary kiln by varying a gas input rate and residence time of the powdery mixture, and the residence time may be adjusted by varying a retort tilt angle and the retort rotation speed, but if the packing ratio is excessively high, there is a risk of a reduction in the quality of the calcined material, while if the packing ratio is excessively low, there is a risk of inadequate producibility being achieved. Accordingly, the packing ratio of the powdery mixture is preferably around 3%-30%, and more preferably around 5%-20%.

### (Furnace-Internal Air Speed and Dew Point)

The furnace-internal air speed and dew point may both be adjusted by varying the gas input rate. When the gas input rate is low and the dew point is excessively high, condensation is especially produced around the retort inlet where the powdery mixture is introduced, irregular agglomeration/sintering, etc. of primary particles and secondary particles arises due to Li dissolving from the lithium compound in the powdery mixture, and there is a risk of a reduction in the quality of the calcined material, while if the gas input rate is high and the furnace-internal air speed is excessively high, this risks leading to selective scattering (separation) of the powdery mixture. The skilled person knows how to select an appropriate gas input rate. Preferably, the input gas rate (IGR) corresponds to the output gas rate (OGR; from the raw material) multiplied with a factor a=1-2.5:

$$IGR = O G R \times a ; a = 1 - 2.5 .$$

### (Temperature Increase Rate)

The temperature increase rate in relation to the powdery mixture being calcined may be adjusted by setting the temperature in the rotary kiln. If the temperature increase rate is excessively low, there is a risk of inadequate producibility being achieved, while if the temperature increase rate is excessively high, the lithium conversion reaction is inadequate and localized lithium conversion reactions occur so that uniformity is not achieved, and therefore there is a risk of a reduction in the quality of the calcined material. The skilled person knows how to select an appropriate temperature increase rate for the specific system. Preferably however, this is in the range of 200° C./h to 2000° C./h.

### (Surface Temperature of Furnace Core Tube)

If the maximum temperature of the powdery mixture is excessively low when it is lifted and agitated by means of the rotary kiln in which one or more lifting blades are provided on the surface portion inside the furnace core tube and the powdery mixture is calcined while being constantly fluidized, then there is a risk of a reduction in the quality of the calcined material, while if the maximum temperature is excessively high, crystal growth progresses in parallel with the lithium conversion reaction, and there is a risk of a reduction in the quality of the calcined material. In this case, the melting point varies according to the type of lithium compound constituting the powdery mixture, so the calcination temperature also varies. For example, when the lithium compound is lithium hydroxide, the temperature setting in the rotary kiln is appropriately adjusted while also taking account of the packing ratio of the powdery mixture so that the maximum temperature of the powdery mixture is preferably around 500° C.-650° C., and more preferably around 530° C.-630° C., and the powdery mixture is preferably calcined by setting the surface temperature of the furnace core tube heated by means of a heater at 400° C. or greater or 500° C. or greater, and 1000° C. or less or 850° C. or less, i.e. preferably from 400 to 1000° C., in particular from 500 to 850° C., more particularly from 500 to 700° C., specifically from 550 to 700° C. More generally speaking, the maximum temperature of the powdery mixture is preferably around 500° C. to at most 250° C. above the melting point of the lithium compound used in step (1) or around 500° C. to at most 200° C. above the melting point of the lithium compound used in step (1), and specifically around 530° C. to at most 170° C. above the melting point of the lithium compound used in step (1), and the powdery mixture is preferably calcined by setting the surface temperature of the furnace core tube heated by means of a heater at 400° C. or greater or 500° C. or greater, and 1000° C. or less or 850° C. or less, i.e. preferably from 400 to 1000° C. in particular from 500 to 850° C., more particularly from 500 to 700° C., specifically from 550 to 700° C.

Independently from the apparatus used in step (2), the powdery mixture obtained in step (1) is preferably heated in step (2) to a temperature of the powdery mixture of 350 to 950° C., e.g. to a temperature of the powdery mixture of 450 to 800° C. or 350° C. to at most 250° C. above the melting point of the lithium compound used in step (1), or 350° C. to at most 200° C. above the melting point of the lithium compound used in step (1), or 450° C. to at most 200° C. above the melting point of the lithium compound used in step (1), or 500° C. to at most 200° C. above the melting point of the lithium compound used in step (1), or 530° C. to at most 170° C. above the melting point of the lithium compound used in step (1).

In step (2), there is no particular limitation as to the calcination atmosphere, and it should be an atmosphere such that the lithium conversion reaction and crystal growth proceed reliably and uniformly, and examples of atmospheres that may be used include a decarboxylated oxidizing gas atmosphere having a carbon dioxide concentration of 30 ppm or less, and an oxygen atmosphere with an oxygen concentration of preferably 80 vol % or greater and more preferably 90 vol % or greater.

There is no particular limitation as to the calcination time, and it should be a time such that the lithium conversion reaction and crystal growth proceed reliably and uniformly, for example a time of around 1 hour-12 hours or around 2 hours-10 hours is preferred.

### <Step (3)>

The intended positive electrode active material for a nonaqueous electrolyte secondary battery may be produced by performing step (1) and step (2) in succession, as described above, but a step (3) in which the calcined material obtained in step (2) is further calcined may also be carried out in the production method of the present invention. By performing this step (3), more reliable and uniform crystal growth can be achieved, and there is a further improvement in the quality of the resulting positive electrode active material.

Moreover, in the production method of the present invention, the step (3) as described above may also be performed after addition of additives to the calcined material obtained in step (2). When additives are added to the calcined material obtained in step (2) in this way, the effect which is demonstrated is different from when the additives are added at the time of mixing of the precursor compound and the lithium compound in step (1), and improved quality of the resulting positive electrode active material can be envisaged. It should be noted that there is no particular limitation as to the additives, and compounds of the element Me or lithium compounds may be appropriately selected for use, and methods of addition that may be used include addition in powder form or spray addition in solution form.

When calcination is performed in step (3), the calcined material is packed in a calcination vessel such as a saggar or crucible, and equipment such as a roller hearth kiln may be used, or it is also possible to use a rotary kiln in the same way as with the calcination in step (2). Equipment enabling fine adjustments to conditions suitable for crystallization is preferably selected appropriately for use in the calcination of step (3).

In step (3) also, there is no particular limitation as to the calcination atmosphere, and it should be an atmosphere such that crystal growth proceeds more reliably and uniformly, and examples of atmospheres that may be used include a decarboxylated oxidizing gas atmosphere having a carbon dioxide concentration of 30 ppm or less, and an oxygen atmosphere with an oxygen concentration of preferably 80 vol % or greater and more preferably 90 vol % or greater.

The product of step (2) is generally cooled before being subjected to step (3), but to avoid or reduce heat loss and energy consumption, cooling in-between these steps might be skipped. If no additives are added before or during step (3), if step (3) is carried out in the same reaction vessel as step (2) and if the calcination atmosphere is not changed, step (3) means prolonging reaction time, optionally under temperature change.

The calcination temperature should be appropriately adjusted according to the maximum temperature of the powdery mixture during the calcination in step (2) and the composition of the intended positive electrode active material, but the calcination temperature is preferably adjusted so that the maximum temperature of the calcined material from step (2) is around 700° C.-1000° C.

There is no particular limitation as to the calcination time, and it should be a time sufficient to obtain a positive electrode active material having the desired crystal structure, for example a time of around 1 hour-12 hours or around 2 hours-10 hours is preferred.

When the positive electrode active material obtained via the sequence of steps (1) and (2), and also step (3) as required, is a high-Ni positive electrode active material comprising Ni as the element Me and having an Ni content of 80 mol % or greater, for example, there is a possibility of a larger amount of lithium compound remaining on a particle surface layer (referred to below as the residual Li compound) as compared to a low-Ni positive electrode active material having a small Ni content, the residual Li compound being the total of unreacted lithium compound and a lithium compound fraction leaving the crystal structure for the particle surface layer during the calcination step. The amount of residual Li compound may be reduced by subjecting the positive electrode active material to a water washing treatment, or by surface treating surfaces of the primary particles and/or secondary particles of the positive electrode active material.

Additionally, even if the positive electrode active material obtained by the sequence of steps (1) and (2) is a positive electrode active material having a low Ni content, in the case of secondary particles generally comprising primary particles having a small shape, for example, there is a risk of metal elution by means of hydrogen fluoride because of the large specific surface area thereof, and a surface treatment is sometimes performed. Furthermore, even in the case of secondary particles comprising primary particles having a large shape, what is known as a sintering promoter, such as KOH, may also be used before calcination in order to achieve the primary particle shape, and a water washing treatment may also be performed in order to wash this sintering promoter.

There is no particular limitation as to the method of surface treatment, and it is possible adopt, among others, a method in which aluminum oxide fine particles are caused to adhere to the particle surface layer of the positive electrode active material by a dry method while a shear force is applied, after which a heat treatment is performed at around 300° C.-700° C., and a method in which a predetermined amount of the positive electrode active material is introduced into an aqueous solution in which a predetermined amount of sodium sulfate is dissolved, the materials are agitated for around 5 minutes-10 minutes, dewatered and dried, then heat treated at around 250° C.-700° C. whereby the particle surface layer is covered by an aluminum compound. Furthermore, it is possible to use, e.g. a boron compound or a tungsten compound in the surface treatment, in addition to an aluminum compound, and the compound may be selected in accordance with the usage. Additionally, two or more types of compounds may also be used at the same time.

The positive electrode active material for a nonaqueous electrolyte secondary battery produced by the production method according to the present invention may comprise a lithium composite oxide containing Li and at least one type of element Me, and there is no particular limitation as to the composition thereof, but it preferably has a composition represented by the following formula (I):

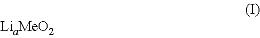

(in the formula, Me is an element other than Li and O, and 0.955≤a≤1.40).

In the positive electrode active material having a composition represented by formula (I) above, the amount a of Li, in other words a ratio (Li/Me) of the amount of Li and the total amount of the element Me is preferably 0.95≤a≤1.40, more preferably 0.95≤a≤1.25, and particularly preferably 0.965≤a≤1.15. Also independently from formula (I), in the positive electrode active material the ratio (Li/Me) of the amount of Li and the total amount of the element Me is preferably 0.95≤a≤1.40, more preferably 0.955≤a≤1.25, and particularly preferably 0.96≤a≤1.15.

In the positive electrode active material having a composition represented by formula (I) above, Me is preferably at least Ni, and more preferably at least Ni, Co and Al and/or Mn. When Me is at least Ni, the amount of Ni, in other words a ratio (Ni/Me) of the amount of Ni and the total amount of the element Me is preferably 0.3<b≤1, more preferably 0.5<b<1, and particularly preferably 0.8<b<1. Also independently from formula (I), if the positive electrode active material contains Ni, the ratio (Ni/Me) of the amount of Ni and the total amount of the other element(s) Me is preferably 0.3<b≤1, more preferably 0.5<b<1, and particularly preferably 0.8<b<1.

The characteristics of the positive electrode active material for a nonaqueous electrolyte secondary battery produced by the production method according to the present invention vary mainly according to the composition thereof, so they cannot be specified exactly, but the average particle size of the secondary particles (average secondary particle size) and the average crystallite size are preferably values in the ranges indicated below, for example.

The average secondary particle size varies according to the intended usage of the positive electrode active material, but it may be determined while taking account of characteristics including increased capacity with higher filling properties and high cycle characteristics, and the average secondary particle size is preferably around 1 μm-30 μm, and more preferably around 2 μm-25 μm, for example.

The crystallite size may be adjusted by means of the desired composition and the primary particle size and secondary particle size, and is preferably around 50 nm-600 nm, and more preferably around 60 nm-500 nm.

In the present specification, the secondary particle size is a value obtained on the basis of an electron microscope photograph (SEM photograph) of the secondary particles of the positive electrode active material image; especially of an SEM photograph at an acceleration voltage of 10 kV using a scanning electron microscope SEM-EDS [field emission scanning electron microscope JSM-7100F: produced by JEOL Ltd.]. Here, the scale which is displayed in the electron microscope photograph is taken as a reference scale.

In the present specification, the crystallite size is a value determined by obtaining XRD diffraction data of the positive electrode active material, especially by obtaining XRD diffraction data by the following method and then performing a Rietveld analysis.

The XRD diffraction data of the positive electrode active material was obtained under the following X-ray diffraction conditions using an X-ray diffraction apparatus [SmartLab, produced by Rigaku Corp.], after which a Rietveld analysis was performed using this XRD diffraction data, with reference to “R. A. Young, ed., “The Rietveld Method”, Oxford University Press (1992)”.

### (X-Ray Diffraction Conditions)

Radiation source: Cu-Kα
Acceleration voltage and current: 45 kV and 200 mA
Sampling width: 0.02 deg.
Scanning width: 15 deg.-122 deg.
Scan speed: 1.0 steps/second
Divergence slit: ⅔ deg.
Receiving slit width: 0.15 mm
Scattering slit: ⅔ deg.

The positive electrode active material for a nonaqueous electrolyte secondary battery produced by the production method according to the present invention may be contained in a positive electrode of a nonaqueous electrolyte secondary battery, and the nonaqueous electrolyte secondary battery comprises this positive electrode, a negative electrode, and an electrolytic solution comprising an electrolyte.

When the positive electrode is produced, a conductive agent and a binder are admixed with the positive electrode active material by means of a normal process. Acetylene black, carbon black, and graphite, etc. are preferred as conductive agents, for example. Polytetrafluoroethylene and polyvinylidene fluoride, etc. are preferred as binders, for example.

For the negative electrode, it is possible to use not only negative electrode active materials such as lithium metal, graphite, and low-crystallinity carbon materials, for example, but also at least one non-metal or metal element selected from the group consisting of Si, Al, Sn, Pb, Zn, Bi and Cd, or alloys comprising same, or chalcogen compounds comprising same.

Examples of solvents of the electrolytic solution that may be used include organic solvents comprising at least one type of carbonate such as ethylene carbonate, propylene carbonate, dimethyl carbonate and diethyl carbonate, or at least one type of ether such as dimethoxyethane.

Other than lithium hexafluorophosphate (LiPF₆), at least one type of lithium salt such as lithium perchlorate or lithium tetrafluoroborate, for example, may be dissolved in the solvent for use.

### <Action>

By virtue of the production method of the present invention, a positive electrode active material for a nonaqueous electrolyte secondary battery, which is capable of imparting outstanding battery characteristics to a nonaqueous electrolyte secondary battery without any reduction in quality, can be manufactured with good production efficiency.

### EXAMPLES

Representative examples of the present invention and comparative examples will be given below to describe the present invention in specific terms, but the present invention is not limited to these examples. It should be noted that characteristics and methods for obtaining these characteristics, etc. are as given below.

### <XRD Diffraction>

XRD diffraction data of the positive electrode active material was obtained under the following X-ray diffraction conditions using an X-ray diffraction apparatus [SmartLab, produced by Rigaku Corp.], after which a Rietveld analysis was performed using this XRD diffraction data, with reference to “R. A. Young, ed., “The Rietveld Method”, Oxford University Press (1992)”.

### (X-Ray Diffraction Conditions)

Radiation source: Cu-Kα
Acceleration voltage and current: 45 kV and 200 mA
Sampling width: 0.02 deg.
Scanning width: 15 deg.-122 deg.
Scan speed: 1.0 steps/second
Divergence slit: ⅔ deg.
Receiving slit width: 0.15 mm
Scattering slit: ⅔ deg.

<Composition of Precursor Compound and Calcined Material (Positive Electrode Active Material)>

Samples of 0.2 g of the precursor compound and the calcined material (positive electrode active material) were each heated and dissolved in 25 mL of a 20% hydrochloric acid solution, and the materials were cooled then transferred to a 100 mL measuring flask, and pure water was introduced ad 100 ml to prepare an adjusted liquid, the elements of which were quantitatively determined using ICP-AES (Optima 8300, produced by PerkinElmer, Inc.).

### <Coin Cell Employing Positive Electrode Active Material>

A 2032-type coin cell employing the positive electrode active material was produced by using a positive electrode, negative electrode and electrolytic solution produced by the following respective methods.

### (Positive Electrode)

Using acetylene black and graphite as the conductive agent at a weight ratio of acetylene black:graphite=1:1, and using polyvinylidene fluoride as the binder, the positive electrode active material, conductive agent and binder were mixed to achieve a weight ratio of positive electrode active material:conductive agent:binder=90:6:4, and a slurry obtained by mixing these materials with N-methylpyrrolidone was coated on an aluminum foil. The coated aluminum foil was dried at 110° C. to prepare a sheet which was punched to a diameter of 15 mm and then rolled so that the density of a composite material was 3.0 g/cm³, and this was used as the positive electrode.

### (Negative Electrode)

A lithium foil having a thickness of 500 μm punched to a diameter of 16 mm was used as the negative electrode.

### (Electrolytic Solution)

A mixed solvent of ethylene carbonate (EC) and dimethyl carbonate (DMC) was prepared at a volume ratio of EC:DMC=1:2, and a solution obtained by mixing a 1 M LiPF₆ electrolyte therewith was used as the electrolytic solution.

### <Battery Characteristics of Nonaqueous Electrolyte Secondary Battery>

### (Initial Charging Capacity and Initial Charging/Discharging Efficiency)

Using the coin cell produced by the method above, after constant current charging at a current density of 18 mA/g to 4.30 V (upper limit voltage) under a 25° C. environment, constant voltage charging was performed until the current reached 2 mA/g. The capacity at this time was taken as the initial charging capacity (mAh/g).

After a pause of 5 minutes, constant current discharging was performed at a current density of 18 mA/g to 3.00 V under the same environment, and the initial discharging capacity (mAh/g) was measured after a 5 minute pause. It should be noted that the series of steps up to measurement of the initial discharging capacity was taken as a charging/discharging cycle according to condition A.

The initial charging/discharging efficiency was calculated on the basis of the following formula using the measured value of the initial charging capacity and the measured value of the initial discharging capacity.

$$Initial charging / discharging efficiency ( \% ) = ( i nitial discharging capacity / initial charging capacity ) \times 100$$

### Synthesis Example 1: Synthesis of Precursor Compound 1

A nickel sulfate aqueous solution, cobalt sulfate aqueous solution and aluminum sulfate aqueous solution were mixed so that the proportions (molar ratio) of Ni, Co and Al were Ni:Co:Al=89:7:4, and a mixed aqueous solution was obtained. 10 L of pure water to which 300 g of a sodium hydroxide aqueous solution and 500 g of ammonia water had been added was prepared in advance as a mother liquor in a reaction tank, a nitrogen atmosphere was set inside the reaction tank by means of nitrogen gas at a flow rate of 0.7 L/min, and the reaction was also carried out under a nitrogen atmosphere.

After this, the mixed aqueous solution, sodium hydroxide aqueous solution and ammonia water were simultaneously dripped at a predetermined rate while a stirring blade was rotated at 1000 rpm, and, by means of a crystallization reaction in which the dripping amount of alkaline solution was adjusted to achieve a pH of 11.8, the Ni, Co and Al crystallized and coprecipitated so that agglomerated particles were formed, and a coprecipitate was obtained.

After this, the slurry inside the reactor was subjected to solid-liquid separation and further washed with pure water to thereby reduce residual impurities, after which the coprecipitate in a caked state was dried for 12 hours at 110° C. under ambient air atmosphere to obtain precursor compound 1. At this time, D50 in a volume-based particle size distribution of precursor compound 1 was 11.2 μm.

### Synthesis Example 2: Synthesis of Precursor Compound 2

A nickel sulfate aqueous solution, cobalt sulfate aqueous solution and manganese sulfate aqueous solution were mixed so that the proportions (molar ratio) of Ni, Co and Mn were Ni:Co:Mn=5:2:3, and a mixed aqueous solution was obtained. 10 L of pure water to which 300 g of a sodium hydroxide aqueous solution and 500 g of ammonia water had been added was prepared in advance as a mother liquor in a reaction tank, a nitrogen atmosphere was set inside the reaction tank by means of nitrogen gas at a flow rate of 0.7 L/min, and the reaction was also carried out under a nitrogen atmosphere.

After this, the mixed aqueous solution, sodium hydroxide aqueous solution and ammonia water were simultaneously dripped at a predetermined rate while a stirring blade was rotated at 1000 rpm, and, by means of a crystallization reaction in which the dripping amount of alkaline solution was adjusted to achieve a pH of 12.0, the Ni, Co and Mn crystallized and coprecipitated so that agglomerated particles were formed, and a coprecipitate was obtained.

After this, the slurry inside the reactor was subjected to solid-liquid separation and further washed with pure water to thereby reduce residual impurities, after which the coprecipitate in a caked state was dried for 12 hours at 110° C. under ambient air atmosphere to obtain precursor compound 2. At this time, D50 in a volume-based particle size distribution of precursor compound 2 was 5.1 μm.

### Example 1-1: Production of Positive Electrode Active Material

Precursor compound 1 and anhydrous lithium hydroxide were weighed out so that the proportions (molar ratio) of Li and the total amount of Ni, Co and Al were Li/(Ni+Co+Al)=1.02, and the materials were mixed using a mixer to prepare powdery mixture 1. The angle of repose of powdery mixture 1 measured by the injection method was 43.7°.

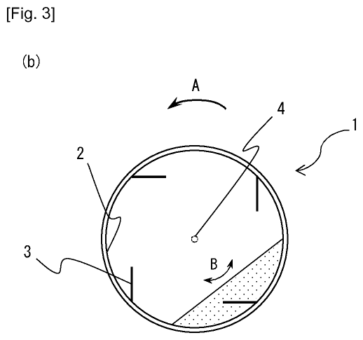

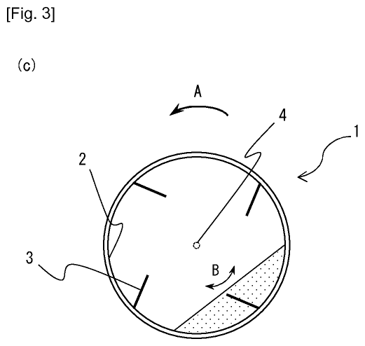

Using a rotary kiln with a retort diameter of 300 mm and having four lifting blades circumferentially provided at an installation angle of 30° on the surface portion inside the furnace core tube, as shown in FIG. 3(a), the powdery mixture 1 was calcined while being constantly fluidized by lifting and agitation over a period of 13 hours under the following conditions in an oxygen atmosphere (oxygen concentration: 97 vol %) (the powdery mixture 1 flowed as shown by the arrow B), and powdery calcined material was continuously produced. It should be noted that in the calcination, the powdery mixture 1 was introduced into the rotary kiln and the time for which the powdery mixture 1 was calcined was set at 4 hours once the powdery mixture was stably and continuously discharged, and the time for which the powdery mixture 1 was calcined at the maximum temperature (approximately 600° C., as indicated below) was approximately 4 hours.

Moreover, the lifting and agitation afforded by the lifting blades was performed so that the height of the topmost portion of the powdery mixture 1 was approximately 1.0 times the height of the topmost portion in a state without the lifting and agitation. Furthermore, the size of the lifting blades was set to enable agitation of 50% of the whole amount of the powdery mixture 1 at a packing ratio of 20% in one rotation.

### (Rotary Kiln Conditions)

Retort rotation speed: 0.9 rpm
Packing ratio: 20%
Furnace-internal air speed and dew point: gas input rate adjusted to 47 L/min
Temperature increase rate: the surface temperature of the furnace core tube was set as indicated below
Maximum surface temperature of furnace core tube: 640° C.
Maximum temperature of powdery mixture 1: approximately 600° C.

The time at which 4 hours had elapsed from the start of calcination once stable discharge had been reached during calcination of the powdery mixture 1 over a 13 hour period was taken as an initial time, and 10 samples were randomly extracted from the fired material obtained after each hour elapsed from the initial time, Li/Me of each sample was identified, and the Li/Me variation coefficient at each elapsed time was calculated from the standard deviation and mean value in accordance with the method described above.

8 kg of the powdery calcined material obtained was then packed in a saggar having a width of 300 mm and a depth of 100 mm and calcined using a rotary hearth kiln under an oxygen atmosphere (oxygen concentration: 97 vol %) over a period of 4 hours so that the maximum temperature of the powdery calcined material was approximately 740° C., and a positive electrode active material was obtained.

The average secondary particle size and the crystallite size of the resulting positive electrode active material were obtained in accordance with the methods described above.

### Example 1-2: Production of Positive Electrode Active Material

A positive electrode active material was obtained in the same way as in example 1-1, except that the rotary kiln of example 1-1 was changed to a rotary kiln having four lifting blades circumferentially provided at an installation angle of 45° on the surface portion inside the furnace core tube, as shown in FIG. 3(b) (the powdery mixture 1 flowed as shown by the arrow B), and the lifting and agitation afforded by the lifting blades was performed so that the height of the topmost portion of the powdery mixture 1 was approximately 1.3 times the height of the topmost portion in a state without the lifting and agitation. Furthermore, the Li/Me variation coefficient at each elapsed time, and the average secondary particle size and crystallite size of the positive electrode active material were also obtained in the same way as in example 1-1.

### Example 1-3: Production of Positive Electrode Active Material

A positive electrode active material was obtained in the same way as in example 1-1, except that the rotary kiln of example 1-1 was changed to a rotary kiln having four lifting blades circumferentially provided at an installation angle of 60° on the surface portion inside the furnace core tube, as shown in FIG. 3(c) (the powdery mixture 1 flowed as shown by the arrow B), and the lifting and agitation afforded by the lifting blades was performed so that the height of the topmost portion of the powdery mixture 1 was approximately 1.6 times the height of the topmost portion in a state without the lifting and agitation. Furthermore, the Li/Me variation coefficient at each elapsed time, and the average secondary particle size and crystallite size of the positive electrode active material were also obtained in the same way as in example 1-1.

### Comparative Example 1-1: Production of Positive Electrode Active Material

Positive electrode active materials were obtained by preparing 10 sheaths in which 8 kg of the powdery mixture 1 prepared in the same way as in example 1-1 was packed into a saggar having a width of 300 mm and a depth of 100 mm, and calcination of the materials for 4 hours using a rotary hearth kiln under an oxygen atmosphere (oxygen concentration: 97 vol %) so that the maximum temperature of the powdery material 1 was approximately 740° C. The positive electrode active material obtained in each sheath was ground, 10 samples were randomly taken, and the Li/Me variation coefficient, and the average secondary particle size and crystallite size of the positive electrode active material were obtained in the same way as in example 1-1.

### Example 2-1: Production of Positive Electrode Active Material

Precursor compound 2 and anhydrous lithium hydroxide were weighed out so that the proportions (molar ratio) of Li and the total amount of Ni, Co and Mn were Li/(Ni+Co+Mn)=1.125, and the materials were mixed using a mixer to prepare powdery mixture 2. The angle of repose of powdery mixture 2 measured by the injection method was 56.3°.

Using a rotary kiln with a retort diameter of 300 mm and having four lifting blades circumferentially provided at an installation angle of 30° on the surface portion inside the furnace core tube, as shown in FIG. 3(a), the powdery mixture 2 was calcined while being constantly fluidized by lifting and agitation over a period of 13 hours under the following conditions in an oxygen atmosphere (oxygen concentration: 97 vol %) (the powdery mixture 2 flowed as shown by the arrow B), and powdery calcined material was continuously produced. It should be noted that in the calcination, the powdery mixture 2 was introduced into the rotary kiln and a time for which the powdery mixture 2 was calcined was set at 4 hours once the powdery mixture was stably and continuously discharged, and the time for which the powdery mixture 2 was calcined at the maximum temperature (approximately 560° C., as indicated below) was approximately 4 hours.

Moreover, the lifting and agitation afforded by the lifting blades was performed so that the height of the topmost portion of the powdery mixture 2 was approximately 1.0 times the height of the topmost portion in a state without the lifting and agitation. Furthermore, the size of the lifting blades was set to enable agitation of 50% of the whole amount of the powdery mixture 2 at a packing ratio of 20% in one rotation.

### (Rotary Kiln Conditions)

Retort rotation speed: 1.1 rpm
Packing ratio: 20%
Furnace-internal air speed and dew point: gas input rate adjusted to 54 L/min Temperature increase rate: the surface temperature of the furnace core tube was set as indicated below
Maximum surface temperature of furnace core tube: 630° C.
Maximum temperature of powdery mixture 2: approximately 560° C.

The time at which 4 hours had elapsed from the start of calcination once stable discharge had been reached during calcination of the powdery mixture 2 over a 13 hour period was taken as an initial time, and 10 samples were randomly extracted from the fired material obtained after each hour elapsed from the initial time, Li/Me of each was identified, and the Li/Me variation coefficient at each elapsed time was calculated from the standard deviation and mean value in accordance with the method described above.

8 kg of the powdery calcined material obtained was then packed in a saggar having a width of 300 mm and a depth of 100 mm and calcined using a rotary hearth kiln under an oxygen atmosphere (oxygen concentration: 97 vol %) over a period of 4 hours so that the maximum temperature of the powdery calcined material was approximately 940° C., and a positive electrode active material was obtained.

The average secondary particle size and the crystallite size of the resulting positive electrode active material were obtained in accordance with the methods described above.

### Example 2-2: Production of Positive Electrode Active Material

A positive electrode active material was obtained in the same way as in example 2-1, except that the rotary kiln of example 2-1 was changed to a rotary kiln having four lifting blades circumferentially provided at an installation angle of 45° on the surface portion inside the furnace core tube, as shown in FIG. 3(b) (the powdery mixture 2 flowed as shown by the arrow B), and the lifting and agitation afforded by the lifting blades was performed so that the height of the topmost portion of the powdery mixture 2 was approximately 1.4 times the height of the topmost portion in a state without the lifting and agitation. Furthermore, the Li/Me variation coefficient at each elapsed time, and the average secondary particle size and crystallite size of the positive electrode active material were also obtained in the same way as in example 2-1.

### Example 2-3: Production of Positive Electrode Active Material

A positive electrode active material was obtained in the same way as in example 2-1, except that the rotary kiln of example 2-1 was changed to a rotary kiln having four lifting blades circumferentially provided at an installation angle of 60° on the surface portion inside the furnace core tube, as shown in FIG. 3(c) (the powdery mixture 2 flowed as shown by the arrow B), and the lifting and agitation afforded by the lifting blades was performed so that the height of the topmost portion of the powdery mixture 2 was approximately 1.7 times the height of the topmost portion in a state without the lifting and agitation. Furthermore, the Li/Me variation coefficient at each elapsed time, and the average secondary particle size and crystallite size of the positive electrode active material were also obtained in the same way as in example 2-1.

### Comparative Example 2-1: Production of Positive Electrode Active Material

Positive electrode active materials were obtained by preparing 10 sheaths in which 8 kg of the powdery mixture 2 prepared in the same way as in example 2-1 was packed into a saggar having a width of 300 mm and a depth of 100 mm, and calcination of the materials for 4 hours using a rotary hearth kiln under an oxygen atmosphere (oxygen concentration: 97 vol %) so that the maximum temperature of the powdery material 2 was approximately 940° C. The positive electrode active material obtained in each sheath was ground, 10 samples were randomly taken, and the Li/Me variation coefficient, and the average secondary particle size and crystallite size of the positive electrode active material were obtained in the same way as in example 2-1.

The Li/Me variation coefficient at each elapsed time determined for the positive electrode active materials obtained in examples 1-1 to 1-3 and comparative example 1-1, and in examples 2-1 to 2-3 and comparative example 2-1 are shown in table 1, and the average secondary particle size and crystallite size of the positive electrode active materials are shown in table 2.

Furthermore, the initial charging capacity and initial charging/discharging efficiency were obtained in accordance with the methods described above as the battery characteristics of a nonaqueous electrolyte secondary battery employing, in the positive electrode thereof, the positive electrode active materials obtained in examples 1-1 to 1-3 and comparative example 1-1, and in examples 2-1 to 2-3 and comparative example 2-1. The results thereof are shown in table 2.

TABLE 1

| | Li/Me variation coefficient (%) at each elapsed time | | | | | | | | | |
|---|---|---|---|---|---|---|---|---|---|---|
| | 4 hours | 5 hours | 6 hours | 7 hours | 8 hours | 9 hours | 10 hours | 11 hours | 12 hours | 13 hours |
| Example 1-1 | 0.32 | 0.34 | 0.33 | 0.30 | 0.31 | 0.32 | 0.31 | 0.32 | 0.34 | 0.31 |
| Example 1-2 | 0.52 | 0.55 | 0.52 | 0.51 | 0.54 | 0.50 | 0.56 | 0.53 | 0.50 | 0.51 |
| Example 1-3 | 0.73 | 0.70 | 0.71 | 0.75 | 0.77 | 0.76 | 0.71 | 0.76 | 0.75 | 0.70 |
| Comparative | 2.23 | 2.00 | 2.69 | 1.33 | 2.00 | 1.76 | 2.89 | 2.31 | 2.95 | 1.68 |
| Example 1-1 | | | | | | | | | | |
| Example 2-1 | 0.47 | 0.48 | 0.51 | 0.44 | 0.44 | 0.45 | 0.52 | 0.48 | 0.44 | 0.47 |
| Example 2-2 | 0.62 | 0.66 | 0.67 | 0.62 | 0.61 | 0.60 | 0.66 | 0.68 | 0.62 | 0.70 |
| Example 2-3 | 0.88 | 0.82 | 0.81 | 0.86 | 0.93 | 0.92 | 0.90 | 0.90 | 0.85 | 0.87 |
| Comparative | 2.69 | 3.56 | 3.20 | 1.98 | 2.32 | 3.45 | 3.02 | 2.49 | 3.52 | 2.40 |
| Example 2-1 | | | | | | | | | | |

TABLE 2

| | Characteristics of positive | | Battery characteristics of nonaqueous | |
|---|---|---|---|---|
| | electrode active material | | electrolyte secondary battery | |
| | Average | | | Initial |
| | secondary | | Initial | charging/ |
| | particle | Crystallite | charging | discharging |
| | size | size | capacity | efficiency |
| | (μm) | (nm) | (mAh/g) | (%) |
| Example 1-1 | 11.6 | 263 | 228 | 89.4 |
| Example 1-2 | 11.7 | 258 | 229 | 90.3 |
| Example 1-3 | 11.3 | 268 | 229 | 90.8 |
| Comparative | 11.7 | 291 | 227 | 87.1 |
| Example 1-1 | | | | |
| Example 2-1 | 5.2 | 311 | 182 | 94.2 |
| Example 2-2 | 5.3 | 318 | 183 | 94.3 |
| Example 2-3 | 5.4 | 306 | 182 | 95.0 |
| Comparative | 5.3 | 337 | 178 | 93.1 |
| Example 2-1 | | | | |

In examples 1-1 to 1-3 and examples 2-1 to 2-3 in accordance with the production method of the present invention, there was no separation of the powdery mixture comprising the precursor compound and the lithium compound, thermal conduction was adequately increased, and the powdery mixture was continuously calcined while being constantly fluidized from the start until the end so that the Li/Me variation coefficient was 1.5% or less for the calcined materials obtained at all predetermined elapsed times (the calcined materials obtained after each hour elapsed), and it is therefore clear that a nonaqueous electrolyte secondary battery employing the positive electrode active materials obtained in these examples has a favorable initial charging capacity and initial charging/discharging efficiency.

In comparative example 1-1 and comparative example 2-1, on the other hand, the powdery mixtures were not calcined while being constantly fluidized from the start until the end such that the Li/Me variation coefficient of the resulting calcined material was 1.5% or less, and therefore the primary particles and the secondary particles formed by agglomerated primary particles did not have a uniform shape, variations in crystallinity occurred, and agglomerations of secondary particles were unevenly distributed in the powder that was formed, so it is clear that a reduction in battery characteristics can be seen in a nonaqueous electrolyte secondary battery employing the positive electrode active materials obtained in these comparative examples.

### INDUSTRIAL APPLICABILITY

A positive electrode active material obtained by means of the production method according to the present invention is capable of imparting outstanding battery characteristics to a nonaqueous electrolyte secondary battery without any reduction in quality.

### KEY TO SYMBOLS

1 Furnace core tube
2 Surface portion
3 Lifting blade
4 Axial center
θ Installation angle

1. A method for producing a positive electrode active material for a nonaqueous electrolyte secondary battery, comprising at least the following steps in succession:
(1) mixing at least a positive electrode active material precursor compound and a lithium compound to prepare a powdery mixture; and
(2) calcining the powdery mixture obtained in step (1) to produce a calcined material,
wherein the precursor compound is a composite compound comprising oxygen (O), and at least one element (Me) other than lithium (Li) and oxygen (O), and
wherein in step (2), the calcined material is produced while the powdery mixture is constantly fluidized at least from the start until the end of calcination, so that the coefficient of variation of the ratio (Li/Me) of the amount of lithium (Li) and the total amount of the element (Me) in the calcined material obtained at a predetermined elapsed time is 1.5% or less for calcined materials obtained at all predetermined elapsed times.

2. The method as claimed in claim 1, wherein constantly fluidizing the powdery mixture at least from the start until the end of calcination comprises a lifting and agitation means for agitating the powdery mixture while lifting the powdery mixture.

3. The method as claimed in claim 2, wherein by the means of the lifting and agitation, the height of the topmost portion of the powdery mixture is 1.0 times to 1.6 times higher than the height of the topmost portion in a state without the lifting and agitation.

4. The method as claimed in claim 2, wherein the calcined material is continuously produced by using a rotary kiln in which one or more lifting blades are provided on a surface portion inside the furnace core tube, in order to perform the lifting and agitation.

5. A method for producing a positive electrode active material for a nonaqueous electrolyte secondary battery, comprising at least the following steps in succession:
(1) mixing at least a positive electrode active material precursor compound and a lithium compound are mixed to prepare a powdery mixture; and
(2) calcining the powdery mixture obtained in step (1) to produce a calcined material,
wherein the precursor compound is a composite compound comprising oxygen (O), and at least one element (Me) other than lithium (Li) and oxygen (O),
wherein in step (2), the calcined material is produced while the powdery mixture is constantly fluidized at least from the start until the end of calcination; and
wherein step (2) is carried out in a rotary kiln in which one or more lifting blades are provided on a surface portion inside the furnace core tube.

6. The method as claimed in claim 5, wherein an installation angle of the one or more lifting blades in the rotary kiln is 15° to 85° in relation to a direction perpendicular to an axial center direction of the furnace core tube.

7. The method as claimed in claim 6, wherein the installation angle of the one or more lifting blades in the rotary kiln is 25° to 70° in relation to a direction perpendicular to an axial center direction of the furnace core tube.

8. The method as claimed in claim 7, wherein the installation angle of the one or more lifting blades in the rotary kiln is 30° to 60°, in relation to a direction perpendicular to an axial center direction of the furnace core tube.

9. The method as claimed in claim 1, wherein in step (2) the powdery mixture obtained in step (1) is heated to a temperature of the powdery mixture of 350° C. to 1000° C.

10. The method as claimed in claim 9, wherein the powdery mixture is calcined while a surface temperature of the furnace core tube is set at 400° C. to 1000° C.

11. The method as claimed in claim 1, wherein Me in the precursor compound comprising oxygen (O) and at least one element (Me) comprises at least one element selected from the group consisting of nickel (Ni), cobalt (Co), manganese (Mn), magnesium (Mg), aluminum (Al), titanium (Ti), zinc (Zn), niobium (Nb), tungsten (W), molybdenum (Mo), vanadium (V), chromium (Cr), calcium (Ca), iron (Fe), gallium (Ga), strontium (Sr), yttrium (Y), ruthenium (Ru), indium (In), tin (Sn), tantalum (Ta), bismuth (Bi), zirconium (Zr), boron (B), and phosphorus (P).

12. The method as claimed claim 1, wherein the precursor compound comprising oxygen (O) and at least one element (Me) is a composite hydroxide, composite oxide, composite carbonate or a mixed form thereof.

13. The method as claimed in claim 11, wherein Me comprises Ni.

14. The method as claimed in claim 13, where the molar ratio b of Ni to the total amount of the other Me is in a range of 0.3<b≤1.

15. The method as claimed in claim 1, wherein the lithium compound is selected from the group consisting of lithium carbonate, lithium hydroxide, anhydrous LiOH, LiOH monohydrate, lithium nitrate, lithium acetate, lithium bromide, lithium chloride, lithium citrate, lithium fluoride, lithium iodide, lithium lactate, lithium oxalate, lithium phosphate, lithium pyruvate, lithium sulfate, lithium oxide, and mixtures thereof.

16. The method as claimed in claim 15, wherein the lithium compound is selected from the group consisting of lithium carbonate, lithium hydroxide, anhydrous LiOH, LiOH monohydrate, and mixtures thereof.

17. The method as claimed in claim 1, wherein the precursor compound and the lithium compound are used in step (1) in such amounts that a ratio a (Li/Me) of the amount of Li and the total amount of the element Me is in a range of 0.95≤a≤1.40.

18. The method as claimed in claim 5, wherein the installation angle of the one or more lifting blades in the rotary kiln is 200 to 800 in relation to a direction perpendicular to an axial center direction of the furnace core tube.

19. The method as claimed in claim 1, wherein in step (2) the powdery mixture obtained in step (1) is heated to a temperature of the powdery mixture from 350° C. to maximally 250° C. above the melting point of the lithium compound used in step (1).

20. The method as claimed in claim 1, wherein Me comprises at least one element selected from the group consisting of nickel (Ni), cobalt (Co), manganese (Mn), magnesium (Mg), aluminum (Al), titanium (Ti), zinc (Zn), niobium (Nb), and tungsten (W).
